(19) United States
(12) Patent Application Publication
(10) Pub. No.: US 2015/0261794 A1
(43) Pub. Date: Sep. 17, 2015

(54) GENERATING OR UPDATING TABLE DATA

(71) Applicant: Apple Inc., Cupertino, CA (US)

(72) Inventors: Matthew R. Lehrian, Pittsburgh, PA (US); Edward P. Hogan, Pittsburgh, PA (US)

(73) Assignee: Apple Inc., Cupertino, CA (US)

(21) Appl. No.: 14/206,911

(22) Filed: Mar. 12, 2014

(51) Int. Cl. G06F 17/30

(52) U.S. Cl. CPC G06F 17/30292; G06F 17/30123

(57) ABSTRACT

The present approaches relate to the creation or updating of a table using data acquired from an external source. In one embodiment, the data acquired from the external source may be dragged-and-dropped onto a new or existing table to invoke execution data import or update routines. In the case of an update, a unique key within the existing table may correspond to a field within the acquired external data set, allowing record matching to be performed such that matched records may be updated and new records may be added to the table. In addition, identified fields in the acquired external data set may correspond to or be matched with columns of the table, allowing data values to be matched and updated regardless of differences in the layout of the table and the acquired external data set.

### BACKGROUND

The present disclosure relates generally to updating tabular data using externally acquired data.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various types of applications, including spreadsheet applications, presentation applications, and word processing applications, may allow a user to generate and display data in the form of tables that consist of rows and columns of cells. For example, a user may generate a table using a spreadsheet application in order to track or analyze a set of quantitative or qualitative data.

In some circumstances, the source of the data may be external to the user. For example, the data to be shown in the table may be generated by a second party. In such circumstances, the user may desire to import the externally generated data to avoid having to manually re-enter each data point. In practice, however, importing a set of data may be confusing or cumbersome, involving obtaining the data in a suitable format, configuring the import processing properly, and subsequently reviewing the imported results to confirm that the import process was performed correctly.

The situation may be further complicated when the external data is updated or changed. In particular, an update or change in the external data source may lead to a need to update any table that is based on this external data in order to keep the external data and the table in synchrony. For example, in some circumstances, a set of external data may be updated on an occasional or periodic basis (e.g., daily, weekly, monthly, annually). In such circumstances, it may be desirable to update a locally maintained table that is based on this data. However, conventional importing processes may be cumbersome or error prone. For example, typical approaches may simply involve a user cutting the new data from the external source file and pasting the updated data over existing values. However, such an approach may be error prone and tedious. Further, any changes made by the user when setting up the existing table (e.g., may changing the layout, formatting style, and so forth) may have to be reapplied after pasting in the new data or may make it impractical to perform a single or simple paste operation.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As described herein, the present approaches relate to the creation or updating of tabular data using data acquired from an external source, such as from an online or network accessible source. In certain implementations, the acquired data may include delimiting features to facilitate parsing of the data into discrete fields. In one embodiment, the data acquired from the external source (i.e., not user generated data) may be dragged-and-dropped onto a new or existing table to invoke execution of one or more data import or update routines. In the case of an update, a unique key within the existing table may correspond to a field within the acquired external data set, allowing record matching to be performed such that matched records may be updated and new records may be added to the table. In addition, identified fields in the acquired external data set may correspond to or be matched with columns of the table, allowing data values to be matched and updated regardless of differences in the layout of the table and the acquired external data set. In this manner, a table may be generated or updated in a simplified manner that is less prone to error.

### BRIEF DESCRIPTION OF THE DRAWINGS

Various aspects of this disclosure may be better understood upon reading the following detailed description and upon reference to the drawings in which:

FIG. 1 is a block diagram of an electronic device that may use the techniques disclosed herein, in accordance with aspects of the present disclosure;

FIG. 2 is a front view of a handheld device, such as an iPhone® by Apple Inc., representing an example of the electronic device of FIG. 1;

FIG. 3 is a front view of a tablet device, such as an iPad® by Apple Inc., representing an example of the electronic device of FIG. 1;

FIG. 4 is a perspective view of a notebook computer, such as a MacBook Pro® by Apple Inc., representing an example of the electronic device of FIG. 1;

FIG. 5 illustrates an example of a screen of a spreadsheet application in accordance with aspects of the present disclosure;

FIG. 6 depicts an example of a formatted table populated with data, in accordance with aspects of the present disclosure;

FIG. 7 depicts an example of contents of a data file, in accordance with aspects of the present disclosure;

FIG. 8 depicts an example of a screenshot of the table of FIG. 6 and a representation of the data file of FIG. 7 being dragged relative to the table, in accordance with aspects of the present disclosure;

FIG. 9 depicts the screenshot of FIG. 8 with the representation of the data file dragged onto the table, in accordance with aspects of the present disclosure;

FIG. 10 depicts the table of FIG. 6 updated based upon the data file contents of FIG. 7, in accordance with aspects of the present disclosure;

FIG. 11 depicts a generalized process flow diagram in the form of an algorithm for generating and updating a table using externally acquired data files, in accordance with aspects of the present disclosure; and

FIG. 12 depicts a further implementation of a process flow in the form of an algorithm for generating and updating a table using externally acquired data files, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The disclosure is generally directed to approaches for updating tabular data using externally acquired data. In certain embodiment, a drag-and-drop implementation is provided whereby an acquired external data file may be dragged-and-dropped onto an existing table, with the data in the external file updating existing fields of the table or, when appropriate, causing new rows or fields to be added. In certain such embodiments, the column headers (or, where appropriate, row headers) may serve as keys to allow field matching between data fields within the table and within the external data. For example, one column header may be designated as containing a key field, allowing corresponding data values to be matched and updated. Where appropriate, the external data may have a format that can be parsed automatically, such as being comma or tab delimited or being in another parseable format, such as an XML or specialized binary format.

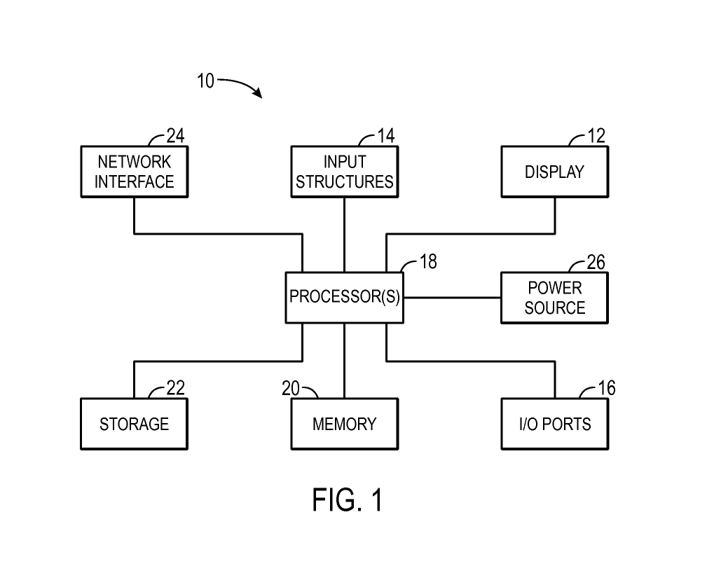

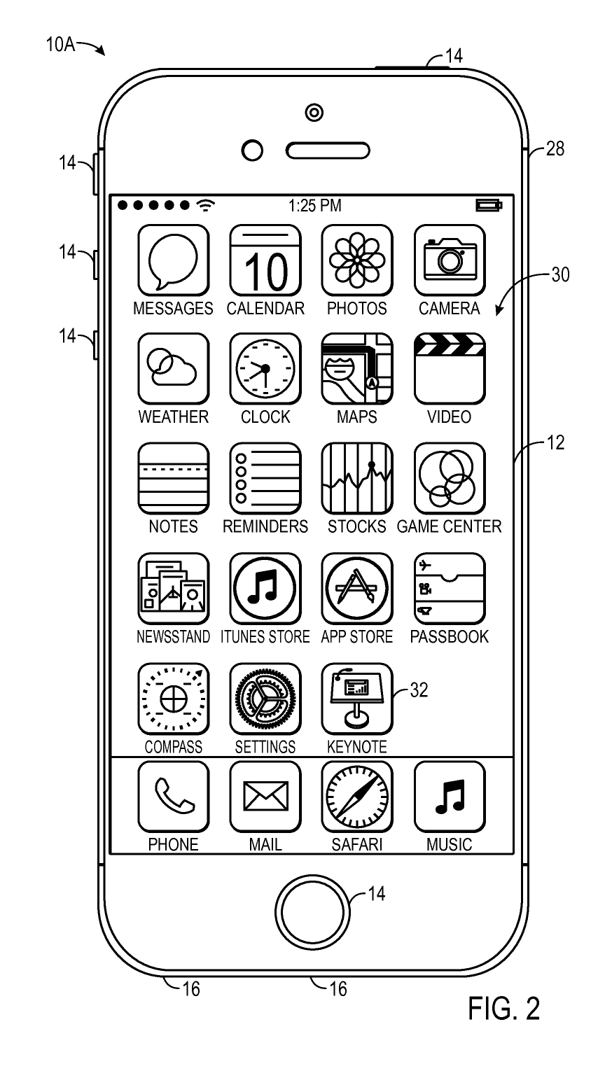

A variety of suitable electronic devices may employ the techniques described herein to provide automated or simplified updating of a table. FIG. 1, for example, is a block diagram depicting various components that may be present in a suitable electronic device 10 that may be used in the implementation of the present approaches. FIGS. 2, 3, and 4 illustrate example embodiments of the electronic device 10, depicting a handheld electronic device, a tablet computing device, and a notebook computer, respectively.

Turning first to FIG. 1, the electronic device 10 may include, among other things, a display 12, input structures 14, input/output (I/O) ports 16, one or more processor(s) 18, memory 20, nonvolatile storage 22, a network interface 24, and a power source 26. The various functional blocks shown in FIG. 1 may include hardware elements (including circuitry), software elements (including computer code stored on a non-transitory computer-readable medium) or a combination of both hardware and software elements. It should be noted that FIG. 1 is merely one example of a particular implementation and is intended to illustrate the types of components that may be present in the electronic device 10. Indeed, the various depicted components (e.g., the processor(s) 18) may be separate components, components of a single contained module (e.g., a system-on-a-chip device), or may be incorporated wholly or partially within any of the other elements within the electronic device 10. The components depicted in FIG. 1 may be embodied wholly or in part as machine-readable instructions (e.g., software or firmware), hardware, or any combination thereof.

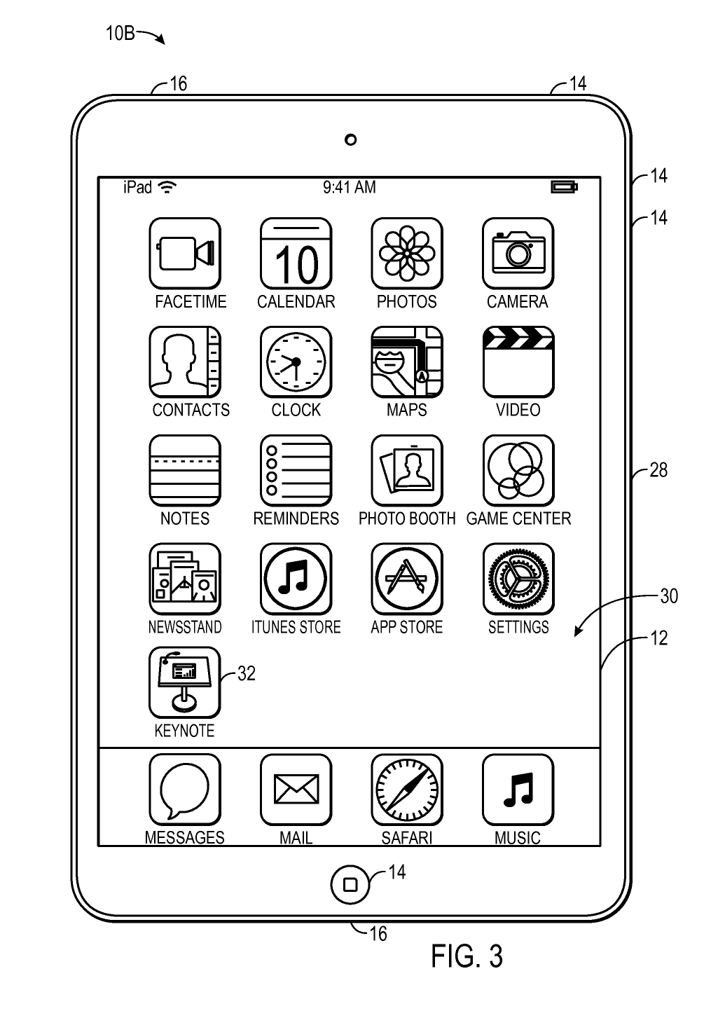

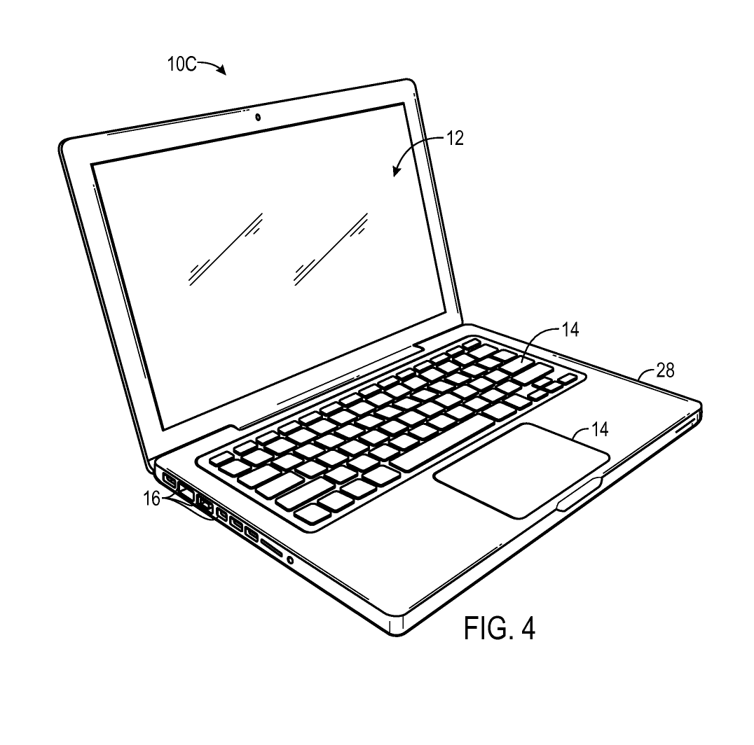

By way of example, the electronic device 10 may represent a block diagram of the handheld device depicted in FIG. 2, the tablet computing device depicted in FIG. 3, the notebook computer depicted in FIG. 4, or similar devices, such as desktop computers, televisions, and so forth. In the electronic device 10 of FIG. 1, the display 12 may be any suitable electronic display used to display image data (e.g., a liquid crystal display (LCD) or an organic light emitting diode (OLED) display). In some examples, the display 12 may represent one of the input structures 14, enabling users to interact with a user interface of the electronic device 10. In some embodiments, the electronic display 12 may be a MultiTouch™ display that can detect multiple touches at once. Other input structures 14 of the electronic device 10 may include buttons, keyboards, mice, trackpads, and the like. The I/O ports 16 may enable electronic device 10 to interface with various other electronic devices.

The processor(s) 18 and/or other data processing circuitry may execute instructions and/or operate on data stored in the memory 20 and/or nonvolatile storage 22. The memory 20 and the nonvolatile storage 22 may be any suitable articles of manufacture that include tangible, non-transitory computer-readable media to store the instructions or data, such as random-access memory, read-only memory, rewritable flash memory, hard drives, and optical discs. By way of example, a computer program product containing the instructions may include an operating system (e.g., OS X® or iOS by Apple Inc.) or an application program (e.g., Numbers®, Pages®, or Keynote® by Apple Inc.) or a suite of such application programs (e.g., iWork® by Apple Inc.).

The network interface 24 may include, for example, one or more interfaces for a personal area network (PAN), such as a Bluetooth network, for a local area network (LAN), such as an 802.11x Wi-Fi network, and/or for a wide area network (WAN), such as a 4G or LTE cellular network. The power source 26 of the electronic device 10 may be any suitable source of energy, such as a rechargeable lithium polymer (Li-poly) battery and/or an alternating current (AC) power converter.

As mentioned above, the electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). FIG. 2 depicts a front view of a handheld device 10A, which represents one embodiment of the electronic device 10. The handheld device 10A may represent, for example, a portable phone, a media player, a personal data organizer, a handheld game platform, or any combination of such devices. By way of example, the handheld device 10A may be a model of an iPod® or iPhone® available from Apple Inc. of Cupertino, Calif.

The handheld device 10A may include an enclosure 28 to protect interior components from physical damage and to shield them from electromagnetic interference. The enclosure 28 may surround the display 12, which may display a graphical user interface (GUI) 30 having an array of icons 32. By way of example, one of the icons 32 may launch a spreadsheet application program (e.g., Numbers® by Apple Inc.), a presentation application program (e.g., Keynote® by Apple Inc.), or a word processing application program (e.g., Pages® by Apple Inc.). User input structures 14, in combination with the display 12, may allow a user to control the handheld device 10A. For example, the input structures 14 may activate or deactivate the handheld device 10A, navigate a user interface to a home screen, navigate a user interface to a user-configurable application screen, activate a voice-recognition feature, provide volume control, and toggle between vibrate and ring modes. Touchscreen features of the display 12 of the handheld device 10A may provide a simplified approach to controlling spreadsheet, or other, application programs executing on the device. The handheld device 10A may include I/O ports 16 that open through the enclosure 28. These I/O ports 16 may include, for example, an audio jack and/or a Lightning® port from Apple Inc. to connect to external devices. The electronic device 10 may also be a tablet device 10B, as illustrated in FIG. 3. For example, the tablet device 10B may be a model of an iPad® available from Apple Inc.

In certain embodiments, the electronic device 10 may take the form of a computer, such as a model of a MacBook®, MacBook® Pro, MacBook Air®, iMac®, Mac® mini, or Mac Pro® available from Apple Inc. By way of example, the electronic device 10, taking the form of a notebook computer 10C, is illustrated in FIG. 4 in accordance with one embodiment of the present disclosure. The depicted computer 10C may include a display 12, input structures 14, I/O ports 16, and a housing 28. In one embodiment, the input structures 14 (e.g., a keyboard and/or touchpad) may be used to interact with the computer 10C, such as to start, control, or operate a GUI or applications (e.g., Numbers®, Pages®, or Keynote® by Apple Inc.) running on the computer 10C.

With the preceding in mind, a variety of computer program products, such as applications or operating systems executing on an electronic device 10, may use or implement the techniques discussed below to enhance the user experience on the electronic device 10. Indeed, any suitable computer program product that provides for the generation and updating of a table of data may employ some or all of the techniques discussed below. While the following examples are provided in the context of a spreadsheet application, the present approaches are suitable for use in other applications (e.g., word processing applications, presentation applications, address book or contact list applications, media storing or playback applications, and so forth) where tables of data may be created, displayed, and updated.

For example, an electronic device 10 may store and run a spreadsheet application 34 (e.g., Numbers® from Apple Inc.) or other suitable application configured to implement the present table generation and updating approaches. The application may be stored as one or more executable routines (which may encode and implement the actions described below) in memory and/or storage (FIG. 1). These routines, when executed, may cause control codes and logic as discussed herein to be implemented and may cause screens as discussed herein to be displayed on a screen of the electronic device or in communication with the electronic device.

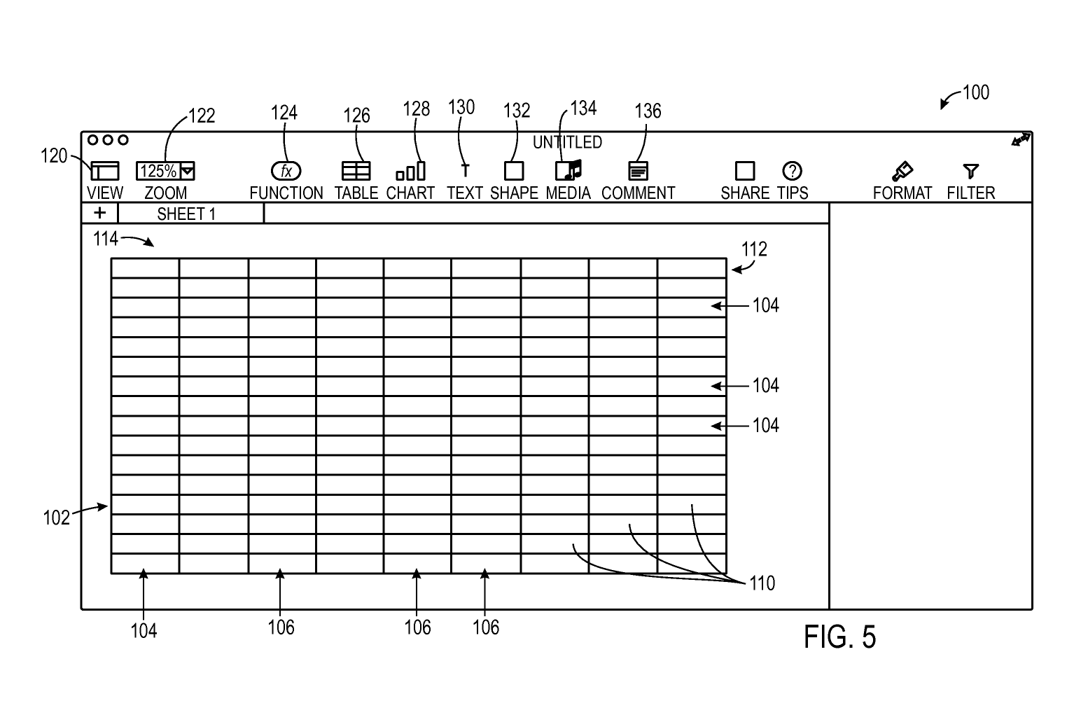

Turning to FIG. 5, an example of a spreadsheet application interface screen 100 is depicted which includes a table 102 having rows 104 and columns 106 of cells 110. Upon selection of a cell 110 within the table 102, a user may be provided a prompt or other entry box by which text, numbers, formula, and so forth may be entered as the contents of a cell 110 or by which the existing contents of a cell 110 may be edited or modified.

In addition, the interface screen 100 may include an interface bar 120 that includes buttons, menus, drop down boxes, and so forth that a user may interact with to invoke various functions within the spreadsheet application. By way of example, in the depicted screen 100, a magnification control 122, function entry button 124, table button 126, chart button 128, text box button 130, shape button 132, media button 134, and comment button 136 are provided. By interacting with these various controls, the user may insert a new table (such as via selection of the table button 126), select a function for use in a cell (such as via selection of the function button 124), insert a comment (such as via selection of the comment button 136), and so forth). In the depicted example, the uppermost row(s) (i.e., header rows 112) and leftmost column(s) (i.e., header columns 114) may be provided.

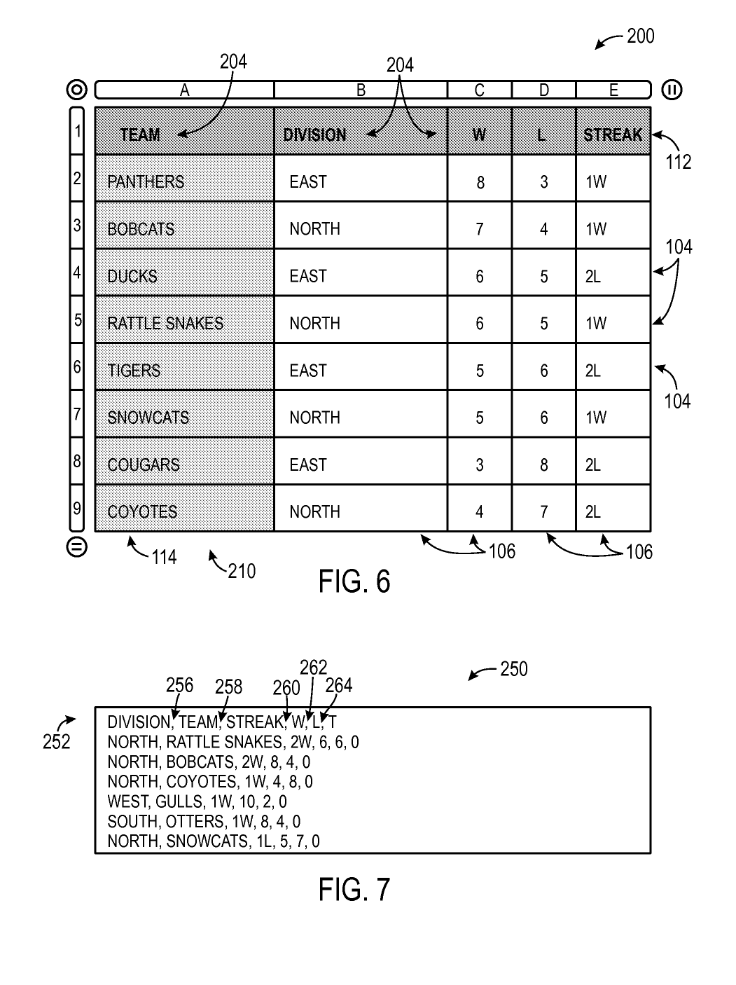

With this spreadsheet and table interface in mind, FIG. 6 depicts an example of a table 200 that may be generated based on a set of externally acquired data that may be updated, such as on an occasional, routine, or periodic basis. As used herein, externally acquired data (also referred to herein as external data) constitutes data that is not generated or created by the user, but is instead generated by a third party or source external to the user who creates and updates the table 200. In the depicted example, the table 200 is populated by a set of data related to sports teams, though examples of other suitable data may include financial or business data, demographic data, medical data, or any other type of data that may be generated by an external source and updated on occasion. In this example, the table 200 includes a header row 112 that lists various field headings 204 for the respective columns 106 of the table 200 and a header column 114 that lists teams for which records are being kept.

In one embodiment, the header column 114 serves as a key column 210 in which the listed values within the key column 210 act as unique identifiers for the records stored in the table 200. By way of example, the key column 210 of table 200 of FIG. 6 corresponds to different sports teams (i.e., “Teams”) within a league, and thus acts as a unique identifier. Conversely, the other columns 106 correspond to non-unique record characteristics, such as the “Division” (e.g., “East” or “North”) different teams belong to, the number of Wins (“W”) and Losses (“L”) each team has, and the current “Streak” for each team. As discussed herein, because the key column 210 corresponds to a unique identifier, the values within the key column 210 may be used in an automated or assisted update process.

For the purpose of the present discussion, the various columns 106 of the table 200 may be equated with different data fields, with the field descriptor or designator populating the respective header cells of header row 112. Conversely, the respective rows 104 of the table may be equated with separate and unique records (e.g., one for each “Team”) as denoted by the unique key in the key column 210. Thus, for each record (i.e., row), a set of data will populate the respective fields (i.e., columns) for that record such that each record has associated data that is defined for each respective field.

In one embodiment, the table 200 may be generated in a manner similar to the updating process described herein. For example, in one embodiment, a new or empty table may be opened by a user, such as that depicted in the example of FIG. 5 or using an interface such as that shown in FIG. 5. In one implementation, a representation of a data file (such as in the form of an icon or graphic representing the file) encoding a set of externally acquired data may be dragged-and-dropped (such as using a mouse, touch screen, or other suitable input mechanism) onto the table 200 into which the externally acquired data is to be imported. In one such embodiment, the file includes field delimiting markers, such as comma characters or tab characters that allow the external data to be parsed into different fields. Further, in one implementation, a record (such as the initial record) within the external data includes field names or headers that may be used in generating the table 200.

Thus, in this example, a representation of an external data file may be dragged-and-dropped onto a blank or new table, such as that shown in FIG. 5. Upon the representation of the external data file being dropped onto the blank or new table, routines may be executed that parse the external data file base on a delimiting characteristic into records and fields that may be used to populate the new or blank table. In one example, a set of field names or headers present in the external data file may be used populate a header row 112 of the new table.

Once generated and populated, the table 200 may be formatted by a user, assuming the initial layout or design of the table does not correspond to the layout desired by the user. As part of this formatting process, the user may designate the key column 210 that will contain a unique identifier that may be used in subsequent updating operations, as discussed herein. In one implementation, designating the key column 210 may include assigning or moving the field corresponding to the unique identifier to the leftmost column (i.e., the header column 114), such as depicted in FIG. 6.

Turning to FIG. 7, an example of an acquired external data file 250 is provided. In this example the acquired external data file 250 includes fields and records corresponding to certain of the fields and records seen in the sample table 200 of FIG. 6. As discussed above, the external file 250 may be suitable for generating a new table, such as by dragging-and-dropping a representation of the external file 250 onto a blank or new table. In addition, as discussed herein, the external file 250 may also be used to update an existing table, such as the table 200 of FIG. 6. In one embodiment, the external file 250 may be acquired or generated on an occasional or periodic basis by a third party relative to the user of the table 200. For example, the external file 250 may be created or provided by an external generator or compiler of data who may make the external data 250 available for download or copying over a network (e.g., the Internet) or via other distribution mechanisms.

Though a discrete data file is discussed herein by way of example, it should be appreciated that in other, more general contexts, the externally acquired or accessed data need not be in provided or acquired in an actual file format. For example, the external data may instead be accessed online (e.g., over the internet) without explicitly downloading or acquiring a discrete data file. Thus, references to and discussion of a data file herein should be understood to encompass not only discrete data files but also, more generally, externally available or acquired data that may be used in table generation or updating as discussed herein.

By way of example, taking FIGS. 6 and 7 together, the table 200 of FIG. 6 lists tabular data, here corresponding to a sports league, that has been formatted by a user to include records for eight teams (i.e., rows 2-9) and having fields for the Team, the Division, wins (W), losses (L), and the current Streak, in that order. The Team field contains unique values for each record and, in this example, populates the key column 210.

In the depicted example, the external file 250 of FIG. 7 contains an update to the data stored in the table 200 of FIG. 6. In particular, the depicted external file 250 includes updated data for certain of the Teams already represented in the Table 200 and for certain of the fields represented in the Table 200. To facilitate explanation of the present approach, however, the example of an external file 250 has been chosen so as to include various differences relative to the table 200 as well.

In the depicted external file 250, the first record 252 within external file 250 is depicted as listing or identifying the corresponding data fields in the subsequent records. For example, for a given record, data preceding the first comma 256 corresponds to the “Division”, data between the first comma 256 and second comma 258 corresponds to the “Team”, data between the second comma 258 and third comma 260 corresponds to the current “Streak”, data between the third comma 260 and the fourth comma 262 corresponds to wins (“W”), data between the fourth comma 262 and the fifth comma 264 corresponds to losses (“L”), and data following the fifth comma 264 and preceding the end of record <EOR> corresponds to ties (“T”).

For the purpose of the present example, the external file 250 includes information for Teams not present in the table 200 of FIG. 6. In particular, the external file 250 includes data for the “Gulls” and “Otters”, for which no corresponding record exists in the table 200. Conversely, the table 200 includes Teams for which no update exists in the external file 250, namely the “Panthers”, the “Ducks”, the “Tigers”, and the “Cougars”. In addition, the external file 250 includes a field, ties (“T”) that has been omitted from the table 200. For example, the field for ties (“T”) may have been initially present in the table 200, but may have been subsequently deleted by the user a part of formatting the table 200 or otherwise modifying the layout of table 200.

In addition, the order of the fields and records between the external file 250 and the table 200 differs. In particular, the table 200 has a layout where the fields, (corresponding to columns of the table 200) are arranged such that the “Team” field is in the first column (i.e., header column 114) as opposed to being the second field, as it is in the external file 250. Such a layout may be desirable in the table 200 since the “Team” field is the only depicted field that contains unique values, and this is suitable to be a key column 210. In particular, in certain implementations it may be desirable for the key column 210 and header column 114 to be the same so that the key field is displayed as the first or leftmost column. In addition to this difference, the ordering of the “Streak”, “W”, and “L” fields also differs between the table 200 and the external file 250.

As a consequence of these differences, updating the table 200 based on the external file 250 cannot be accomplished by simply reading out and applying the data contained in the external file 250 in a linear manner. Instead, in certain implementations, the corresponding fields of the external data file 250 may be mapped to the corresponding fields (displayed in the columns 106) of the table 200 to be updated.

For example, upon parsing the external data file 250, the initial record 252 may include field headings or descriptors that correspond to the headings within the header row 112, which may have been reordered by the user, as in this example. Due to the correspondence between the field descriptors in the initial record 252 of the external field 250 and the headers or descriptors populating the header row 112 of table 200, the update process may be mapped so that data corresponding to a particular field in the external data file 250 is applied to the corresponding column within the table 200. For example, though the “Division” field in the external data file 250 is the first field in each record (i.e., precedes the first comma 256) but is the second column 102 in the table 200, the correspondence between the header information in both the table 200 and external file 250 allows the “Division” field to be mapped so that the “Division” data point for a given record is applied to the proper column (e.g., the second column) in the table 200. Likewise, in the depicted example, the “Streak” field precedes the “W” and “L” fields in the external file 250, but follows these fields in the table 200. As with the “Division” field example, the correspondence between the field headers in the external file 250 and table 200 is leveraged to apply the data from a given field in the external data 250 to the corresponding column 106 of the table 200.

In addition, as previously noted, the external data file 250 may include fields that are not present in the table 200, such as due to the user choosing to exclude or remove the fields in question. For example, the external file 250 includes a field for ties (“T”) that is absent from the table 200. As a result, the absence of this field in the table 200 may result in the “T” field not being imported or not being applied as there is no column 106 of the table mapped to this field.

Conversely, in formatting the table 200, the user may introduce columns that have no corresponding field in the external file 250 (such as a Win Percentage column in the context of the present example) or may intentionally or inadvertently duplicate a column (such as having two columns with the header Streak in the context of the present example). In the instance where a new column has been added for which there is no corresponding field in the external file 250, that cell would be left unfilled by the update process. As will be appreciated, however, a formula present in or applied to the cell may automatically populate the field after application of the update. With respect to the instance of a duplicated column, in such a circumstance the mapping from the external file 250 to the corresponding columns of the table 200 may result in both columns labeled by the duplicate header being updated or populated using the corresponding data from the external file 250.

While the preceding relates the manner in which respective data fields may be mapped to the appropriate columns 106, an additional consideration is matching records between the existing table 200 and the external data file 250. As noted above, in the example of FIGS. 6 and 7, the external file 250 includes records for certain “Teams” already present in the table 200 (i.e., the “Rattle Snakes”, the “Bobcats”, the “Coyotes”, and the “Snowcats”). For these records, the data present in the updated file constitutes an update, and the corresponding data fields in the external file 250 should be mapped to the corresponding columns 106 of table 200 and the data values from these fields in the external file 250 should replace or overwrite the existing entries in the table 200. For those records (e.g., “Teams”) present in the external file 250 for which no corresponding record exists in the table 200 (i.e., the “Gulls” and the “Otters”), a new entry may be generated in the table 200, with the corresponding data fields populated by the corresponding data in the external file 250.

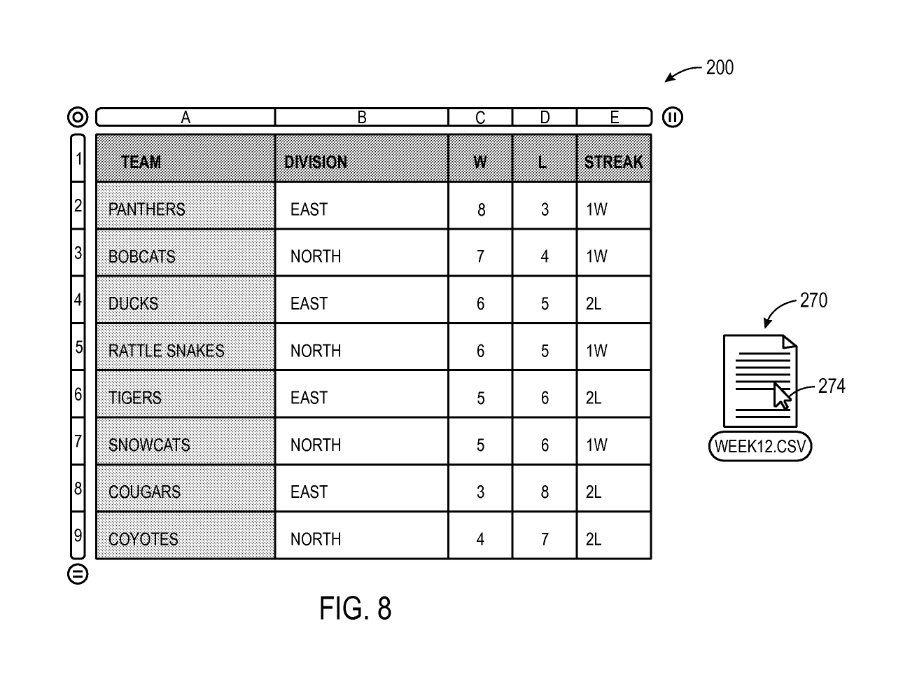

Turning to FIGS. 8-10, a visual example of an implementation of the present approach is depicted. In this example, the table 200 of FIG. 6 is depicted as it might appear on a display 12 of a user. In addition a representation 270 of the externally generated file 250 of FIG. 7 is depicted. Though the representation 270 of the external file 250 is depicted as a graphical representation (e.g., an icon), in other instances the representation 270 may simply be a file name (e.g., a textual representation) or other displayed and manipulable representation of the external file 250. As noted herein, the external file 270 may be generated by or acquired from an external source which may provide updated data on an occasional or periodic basis.

In the depicted example, a displayed file name of the representation (i.e., “Week12.csv”) includes a displayed extension (i.e., “.csv”) indicating that the file is in a comma-separated or comma-delimited format. As noted herein, in certain implementations, the external file 250 may be in such a delimited format (e.g., comma or tab delimited or a parseable XML or specialized binary format), allowing the external file 250 to be easily parsed into corresponding fields of values by an update process.

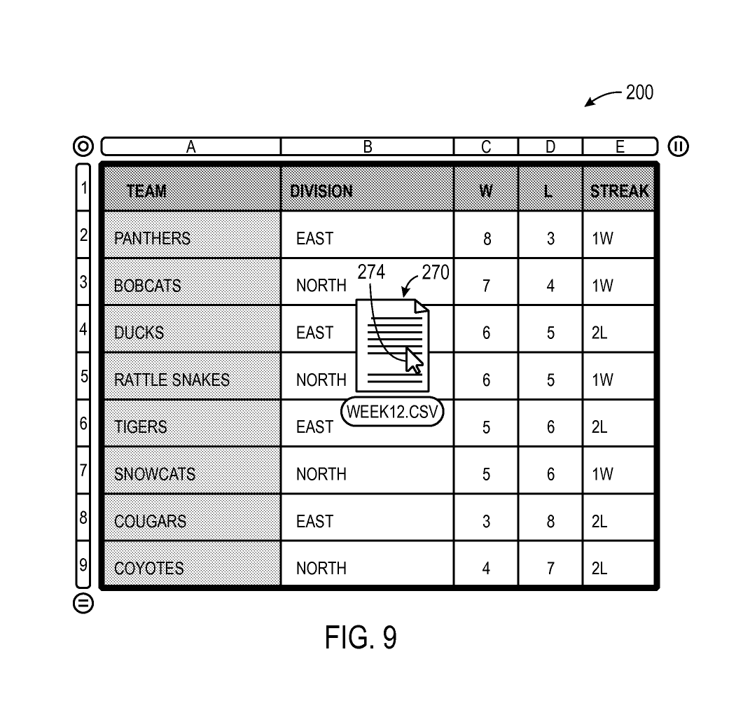

In the depicted example, a cursor 274 is also shown to signify that the representation 270 has been selected and is being “dragged” by the user from one location to another in the displayed interface. Turning to FIG. 9, the representation 270 is shown as having been “dragged” onto the existing table 200. In accordance with a present implementation, such a “dragging” operation may be part of a “drag-and-drop” operation by which a user invokes an update routine or algorithm that updates the table 200 based on the external file 250. In the depicted example, the file representation 270 being dragged over the table 200 causes the table 200 to be highlighted (such as by coloring or thickening the border of table 200) indicating that the data “drop” can be accepted. For example, in such an implementation, if the representation 270 corresponding to the external file 250 is “dropped” onto existing table 200, the table 200 is updated based on the contents of the external file 250.

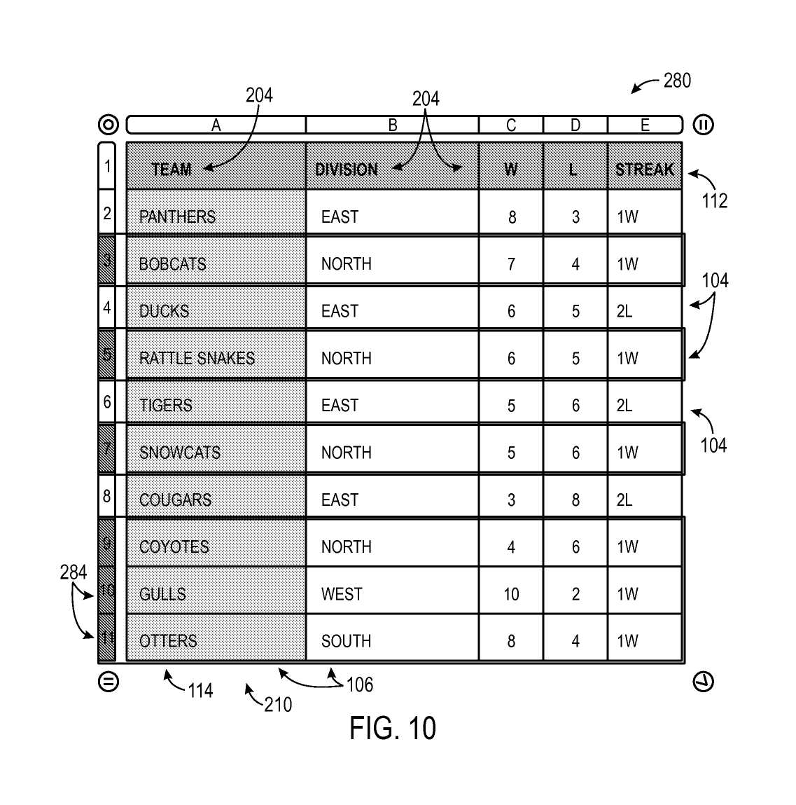

This can be seen in FIG. 10, depicting an updated table 280 generated after the original table 200 is updated or otherwise modified based on the contents of the external file 250. In the depicted example, the key column 210 corresponds to the header column 114 and is populated by a unique variable, here the name of the teams for which data is being stored. Thus, for team names already present in the table 200 and for which data is present in the external file, a match is made based on this unique key and the data fields associated with that record (i.e., the team in this example) updated with the corresponding data values present in the external file 250. For those team names not present in the original table 200 (such as “Gulls” and “Otters” in this example), a new row or record 284 may be added to the table based on the corresponding values contained in the external file 250. By way of example, in updated table 280 rows 10 and 11 have been added that are populated by the data values for the “Gulls” and “Otters” teams contained in the external file 250. In this example, not every record of the table 200 is updated to form the updated table 280. For instance, updated or added records in the updated table 280 are indicated by highlighting the row number (i.e., rows 3, 5, 7, 9-11) in the depicted example.

As previously noted, part of such an update process may include mapping data values from a given field location in the external file 250 to a corresponding location in the table 200 (and 280). For example, looking at row 3 of table 280, the data record corresponding to the “Bobcats” team is depicted. In this example, the team name (“Bobcats”) populates Column A, though in the external file the team name is actually stored in the second field for that record. Embodiments of the present update process, however, map data values between the external file 250 and the table 200 (and updated table 280) so that the correct data values are used to populate the corresponding table columns 106. Similarly, in this example, the first field in the external file 250 corresponds to Division (“North”) which is mapped to Column B in the updated table 280, the third field in the external file 250 corresponds to Streak (“2W”) which is mapped to the Column E, and so forth.

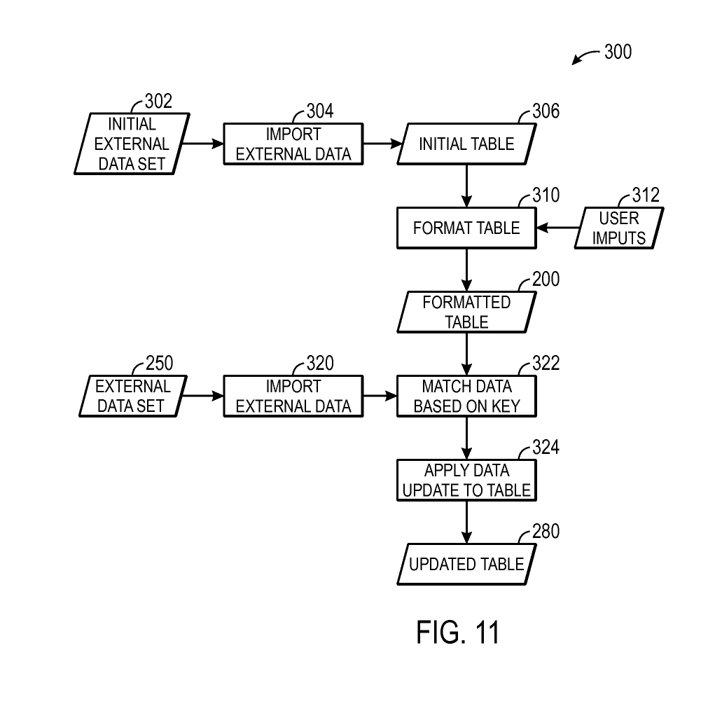

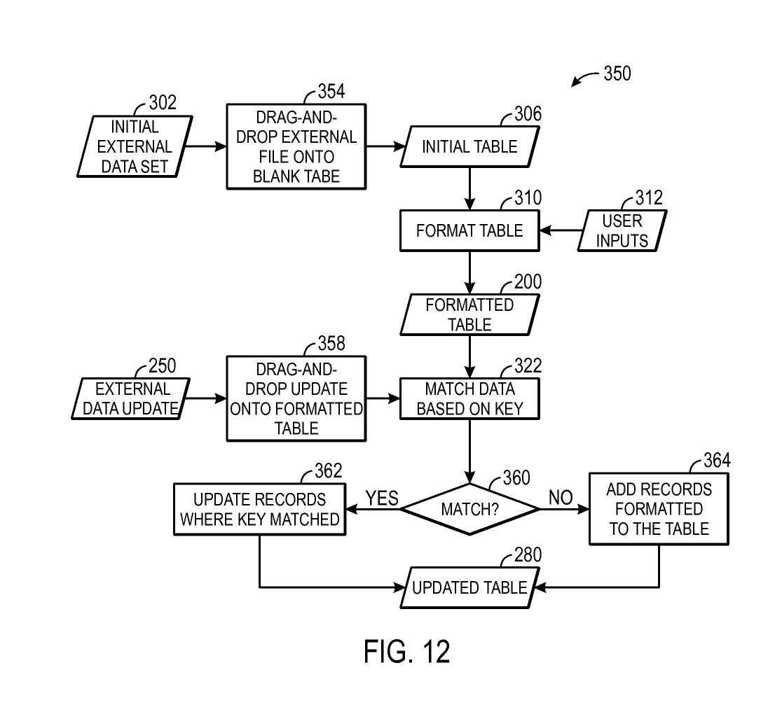

With the preceding examples and discussion in mind, FIGS. 11 and 12 are process flow diagrams depicting algorithms for implementing aspects of the present approaches. In particular, FIG. 11 depicts steps of a generalized algorithm 300 while FIG. 12 depicts a particular implementation of one such algorithm involving drag-and-drop updating of a table 200.

Turning to FIG. 11, in this example of an algorithm the initial table 306 construction is depicted is depicted as a precursor to update procedures. For example, in the depicted embodiment, an initial external data set 302 is acquired or accessed by the user, such as by downloading the file 302 from a network such as the Internet or by receiving the file 302 as an e-mail attachment. As noted herein, the external data set may be a delimited file or otherwise parseable file which may be parsed into corresponding data fields (e.g., columns of a table).

In the depicted implementation, the initial external data set 302 is imported (block 304), such as by invoking suitable data importation routines of a spreadsheet application or other suitable application. To the extent that the initial external data set may be ordered, both in terms of records or fields, the initial table 306 may be constructed or populated to reflect the ordering of records and fields within the initial external data set 302. In the depicted example, the user may format (block 310) the initial table 306 by providing one or more user inputs 312. Examples of such user inputs 312 may include, but are not limited to, deleting a column 106 (i.e., data field) from or adding a column 106 to the initial table 306, reordering the columns 106 of the initial table 306, deleting a row 104 (i.e., data record) from the initial table 306, reordering the rows 104 of the initial table 306, or assigning a column 106 to be a key column 210 of the table 306. Assigning a column 106 to the be the key column 210 may, in some embodiments, involve moving a column 106 of the table 306 that has unique identifiers or values to be a header column 114 of the table 306. Upon application of the user inputs 312, the resulting formatted table 200 is generated and may be used, reviewed, or further formatted by the user. As will be appreciated, the steps involved with formatting the initial table 306 may be omitted if the initial table 306 is in a suitable format when generated. That is, if the initial table is suitably formatted when generated, the initial table 306 may serve as the formatted table 200.

In the depicted implementation, the formatted table 200 is subsequently updated based on one or more sets of externally generated data (i.e., an external data update 250), such as in the form of a periodic data update. In certain implementations, the external data update is delimited (e.g., comma or text delimited) and may have a layout or data configuration similar or identical to that of the initial external data set 302. In the implementation of FIG. 11, the external data update 250, once acquired, is imported (block 320) by parsing the delimited data. Typically one record (e.g., the first record) of the external data update will include field identifiers or headers for the remainder of the data in the external data file. Based on the field identifiers in the external data update 250, the key field may be identified and matched (block 322) with the corresponding key column 210 of the formatted table 200. Based on this match, records in the table 200 may be updated (block 324) based on the data records and values present in the external data update 250 to generate the updated table 280.

Turning to FIG. 12, the depicted algorithm 350 includes certain additional aspects that may be associated with particular implementations of the present approach. For example, as depicted in FIG. 12, a drag-and-drop approach may be employed to invoke the table generation and table update routines. In this example, generation of the initial table 306 may be invoked by dragging-and-dropping (block 354) the initial external data set 302 onto a blank or new table. Similarly, routines for updating of the formatted table 200 may be invoked by dragging-and-dropping (block 358) the external data update 250 onto the formatted table 200.

Upon execution of the update routines a matching step 322 may be invoked to match records in the external data file 250 and the formatted table 200 based on a unique key. As depicted in FIG. 12, this matching process may be implemented so that a match determination is made (decision block 360) based on the field values in the external data update 250 corresponding to the key and on the populated fields of the key column 210 of the formatted table 200. Based on this match determination, records in the table 200 may be updated (block 362) if a matched record is present in the external data update 250. However, if the external data update 250 include a record that has no match in the table 200, the table 200 may be updated (block 364) to include the new record. If the table 200 include records that have no corresponding record in the external data update 250, those records will be not be updated. Based on this update processing, the updated table 280 is generated.

While the update process may be accomplished using a drag-and-drop operation, in other embodiments, such as in the generalized scenario outlined in FIG. 11, the updating process can also be accomplished using a paste-type operation in which the new or updated data is pasted onto the table 200. In order to invoke the update processing as discussed herein, such as the key matching and data field mapping, the specialized update pasting operation may be performed by depressing a modifier key while performing the paste operation or by selecting the paste operation command from a special menu or keystroke option. That is, the specialized paste operation performed in such a manner may be used to invoke the update processing as discussed herein so as to properly match records and match data fields to accomplish a table update as discussed herein.

As discussed herein, the present approach allows a user to easily generate or update a table containing data records using data generated or updated external to the user or system creating or maintaining the table. For example, the source of the data may be an online or network accessible location which occasionally or periodically makes data available in a manner than can be downloaded or acquired as a data file, such as a delimited data file. A user may acquire such a data file from the external source and import the data to create a new table or update an existing table, such as by using a drag-and-drop technique to invoke routines for creating or updating the table. When employed, such drag-and-drop techniques may allow a user to drag-and-drop a representation of the externally acquired data file, such as an icon, onto a new or existing table to invoke the respective routines.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A processor-implemented method for updating a table, comprising:
receiving a user input comprising a representation of an externally generated data file being dragged-and-dropped onto a table storing one or more records, wherein the table comprises at least a key column storing a unique identifier for each record stored in the table;
in response to the user input, executing an update operation in which update records stored in the externally generated data file are parsed and matched to the records of the table using the unique identifier stored in the key column; and
for records having a match in both the externally generated data file and the table, updating one or more data fields in the table for the matched records based on one or more corresponding data fields in the externally generated data file to generate an updated table.

2. The processor-implemented method of claim 1, wherein the representation of the externally generated data file comprises an icon or file name.

3. The processor-implemented method of claim 1, wherein the externally generated data file comprises a data update to the one or more records stored in the table.

4. The processor-implemented method of claim 1, wherein the key column comprises a header column of the table.

5. The processor-implemented method of claim 1, wherein row of the table correspond to the one or more records and columns of the table correspond to the one or more data fields.

6. The processor-implemented method of claim 1, wherein updating the one or more data fields in the table based on one or more corresponding data fields in the externally generated data file comprises mapping the one or more corresponding data fields to the one or more data fields of the table based on headers within the columns of the table.

7. The processor-implemented method of claim 1, further comprising:
for records not having a match in both the externally generated data file and the table, appending a new record to the table for the unmatched record and populating the one or more data fields of the new record based on the one or more corresponding data fields in the externally generated data file.

8. A non-transitory, tangible computer-readable medium encoding processor-executable routines, wherein the routines, when executed by a processor cause acts to be performed comprising:
displaying a formatted table comprising a plurality of records, each record comprising a plurality of data fields, wherein one of the data fields comprises a unique key for the respective record;
receiving an input comprising a representation of a data file being dragged-and-dropped onto the formatted table;
in response to the input, parsing the data file into records and data fields and matching the records encoded in the data file with the plurality of records of the table;
if a record stored in the data file has a matching record in the table, updating the matching record in the table based on the corresponding data fields in the data file; and
if a record stores in the data file has no matching record in the table, adding a new record to the table based on the corresponding data fields in the data file.

9. The non-transitory, tangible computer-readable medium of claim 8, wherein the formatted table is formatted such that columns of the table corresponding to the data fields have a different order than the corresponding data fields in the data file.

10. The non-transitory, tangible computer-readable medium of claim 8, wherein the unique key populates a key column of the table.

11. The non-transitory, tangible computer-readable medium of claim 8, wherein the data file comprises a periodic update of one or more records stored in the table.

12. The non-transitory, tangible computer-readable medium of claim 8, wherein matching the records encoded in the data file with the plurality of records of the table is based on the unique key for each record stored in the table.

13. A processor-based system, comprising:
a display;
a memory storing one or more routines; and
a processing component configured to execute the one or more routines stored in the memory, wherein the one or more routines, when executed by the processing component, cause acts to be performed comprising:
displaying a table comprising rows, wherein each row corresponds to a unique record and includes a unique key, and columns, wherein each column corresponds to a respective data field;
receiving an update input related to a set of externally generated data, wherein the externally generated data comprises one or more update records;
in response to the update input, updating records in the table for which a match exists in the externally generated data as determined by the unique key.

14. The processor-based system of claim 13, wherein the one or more routines, when executed by the processing component, cause further acts to be performed comprising:
in response to the update input, adding records to the table corresponding to records in the externally generated data for which no match is identified based on the unique key.

15. The processor-based system of claim 13, wherein the update input comprises one of a drag-and-drop operation onto the table or a modified paste operation.

16. The processor-based system of claim 13, wherein the externally generated data comprises an update data file acquired from an online source.

17. The processor-based system of claim 13, wherein the externally generated data is a comma delimited file, a tab delimited file, an XML file, or a specialized binary file.

18. A processor-implemented method for modifying a table, comprising:
in response to an update file being dragged-and-dropped onto a table, performing a matching operation that matches records in the update file and the table based on a unique key defined for the records;
determining a mapping of data fields in the update file to columns in the table; and
based on the mapping and the results of the matching operation, updating the table based on the update file such that records in the update file having a match in the table are updated based on the update file and records in the update file not having a match in the table are added to the table.

19. The processor-implemented method of claim 18, wherein determining the mapping comprises comparing headers of columns in the table with delimited field identifiers within the update file.

20. The processor-implemented method of claim 18, wherein the update file is acquired from an online source at periodic intervals.

21. The processor-implemented method of claim 18, wherein the unique key is defined by a header column of the table.

22. A non-transitory, tangible computer-readable medium encoding processor-executable routines, wherein the routines, when executed by a processor cause acts to be performed comprising:
receiving a command to update a table based on the contents of an update file, wherein the table comprises one or more records stored in rows of the table, wherein each record comprises one or more data fields stored in columns of the table;
in response to the command, determining a mapping between data fields of the update file and columns of the table;
in response to the command, determining which records of the table have corresponding update data in the update file based on a unique key defined for each record in the table; and
for those records of the table having corresponding update data, updating the respective records based on the update data.

23. The non-transitory, tangible computer-readable medium of claim 22, wherein the routines, when executed by the processor cause further acts to be performed comprising:
for update records in the update file for which there is no corresponding record in the table, adding a new record to the table.

24. The non-transitory, tangible computer-readable medium of claim 22, wherein the update file comprises a delimiting character separating data fields in the update file.

25. The non-transitory, tangible computer-readable medium of claim 22, wherein determining the mapping between data fields of the update file and columns of the table comprises comparing headers of the respective columns with field identifiers contained within the update file.
